(19) United States
(12) Patent Application Publication
(10) Pub. No.: US 2009/0271945 A1
(43) Pub. Date: Nov. 5, 2009

(54) Air blower

(76) Inventor: Lanny J. Ludwigson, Eleva, WI (US)

Correspondence Address: Richard O. Bartz, Suite 350, 6750 France Avenue South,, Edina, MN, 55435, US

(21) Appl. No.: 12/387,650

(22) Filed: May 5, 2009

Related U.S. Application Data
(60) Provisional application No. 61/126,481, filed on May 5, 2008.

(51) Int. Cl. A47L 9/02; F04B 35/04; H05B 3/02; F04B 35/00

(52) U.S. Cl. 15/415.1; 417/410.1; 219/507; 417/364

(57) ABSTRACT

An air blower has a motor drivably connected to an impeller operable to move air through a spout and into a nozzle releasably mounted on the spout. A heater assembly located with the nozzle operates to heat air flowing in the nozzle and discharge hot air from the nozzle.

### CROSS REFERENCE TO RELATED APPLICATION

This application claims the priority of U.S. patent application Ser. No. 61/126,481 filed May 5, 2008.

### FIELD OF THE INVENTION

The invention is related to air moving devices operable to discharge a stream of cool air or hot air. The air moving device is a handheld air blower equipped with a heater assembly operable to heat air discharged by the air blower.

### SUMMARY OF THE INVENTION

The air blower of the invention operates to selectively direct a stream of hot air of cool air to selected locations. The hot air can be directed to wet, snow and ice covered surfaces to clear these surfaces. The cool air can be directed to surfaces having dirt and debris to clear these surfaces. The air blower is not limited to any particular use.

The air blower has a housing with an internal chamber with a fan or impeller operable to move air from a base to an air discharged spout. A motor, such as an electric motor or an internal combustion engine, mounted on the housing is drivably connected to the impeller. The electric motor is wired to a switch connected to an electric power source. When the switch is activated the motor drives the impeller which moves air through the air blower. An elongated tubular nozzle releasably mounted on the spout has an air exit end that directs air in a selected direction to an object or surface. The nozzle has an inside wall surrounding a passage for flowing air. An air heater assembly located in the nozzle passage downstream from the spout operates to heat the air flowing in the nozzle passage whereby hot air is discharged from the exit end of the nozzle. The heater assembly includes a heating element, such as a wire coil, wired to the switch connected to the electric power source. The switch is operable to only connect the motor to the electric power source or alternatively concurrently connect the motor and heating element so that air flowing in the nozzle passage is heated resulting in hot air being discharged from the nozzle. An alternative embodiment of the air blower has an internal combustion engine drivably connected to an impeller for moving air through a spout into a nozzle. A heater assembly located within the nozzle heats the air within the nozzle whereby hot air is dispensed from the nozzle. The heater assembly comprises a magnetic heater having permanent magnets located adjacent a rotatable ferrous metal sleeve surrounded with a copper member whereby magnetic flux forces generate heat that is transferred to the air flowing through the heater assembly and nozzle.

### DESCRIPTION OF THE DRAWINGS

FIG. 1 is a perspective view of the air blower of the invention;

FIG. 2 is an enlarged rear elevational view of the air blower of FIG. 1;

FIG. 3 is side elevational view of the air discharge nozzle of the air blower of FIG. 1;

FIG. 4 is an enlarged sectional view taken along line 4-4 of FIG. 3;

FIG. 5 is an enlarged sectional view taken along line 5-5 of FIG. 3;

FIG. 6 is a side elevational view of a first embodiment of the air blower of FIG. 1;

FIG. 7 is a perspective view of a second embodiment of the air blower of FIG. 1;

FIG. 8 is an enlarged sectional view taken along line 8-8 of FIG. 7;

FIG. 9 is an enlarged top plan view of the nozzle of FIG. 7;

FIG. 10 is a sectional view taken along the lien 10-10 of FIG. 9;

FIG. 11 is an enlarged sectional view taken along the line 11-11 of FIG. 9; and

FIG. 12 is an enlarged sectional view taken along the line 12-12 of FIG. 9.

### DESCRIPTION OF THE INVENTION

The invention is a handheld air blower 10 having air discharge nozzle 14 with a heater assembly 18 operable to heat air discharged by the blower. The heater assembly 18 is selectively operable to heat air in the air discharge nozzle 14 or allow cool air to flow through nozzle 14 to a selected location.

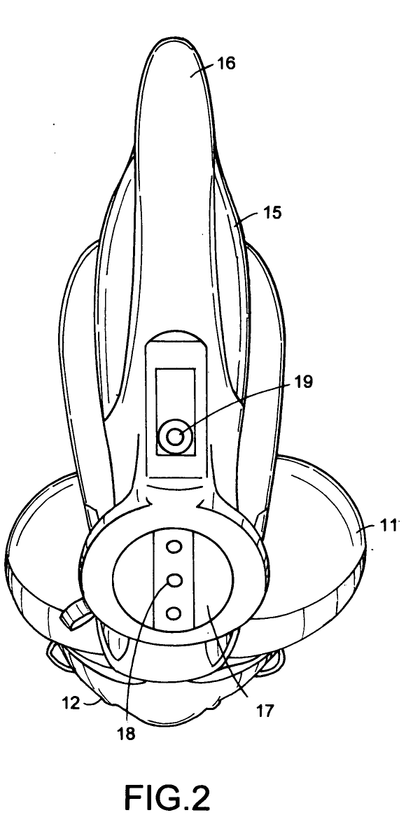

Air blower 10 has a generally cylindrical housing 11 surrounding a fan or impeller (not shown) operable to draw air through base 12 and discharge air to a spout 13 releasably connected to nozzle 14. Base 12 joined to the bottom of housing 11 has a plurality of openings to allow ambient air to flow into base 12 and housing 11. Nozzle 14 telescopes over a section of spout 13 and is held thereon with a releasable button or lock member 20. Other types of mountings and latches can be used to hold nozzle 14 on spout 13. An electric motor 15 mounted within housing 11 is operably coupled to the impeller to rotate the impeller. An inverted generally U-shaped handle 16 on the top of housing 11 facilitates hand carrying of air blower 10. The rear of housing 11 and handle 16 has a cylindrical recess 17 and electric connectors 18, shown in FIG. 2, adapted to accommodate an electric cord connected to an electric power source. A switch 19 mounted in the back of handle 16 is operable to connect electric power to motor 15 whereby motor 15 operates to rotate the impeller which moves air from base 12 to spout 13 and through nozzle 14 to a selected location.

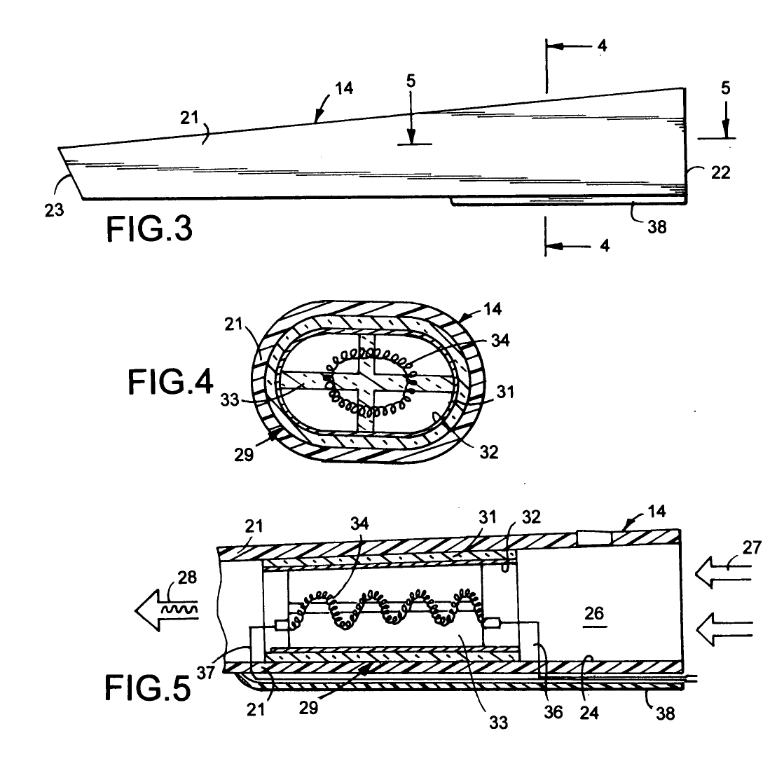

As shown in FIG. 3, nozzle 14 has a linear tubular body 21 that tapers from a large end 22 to a small end 23. Body 21 has a generally oval cross section, as seen in FIG. 4. For example, body 21 has a length of 48 cm with a large end dimension of 8 cm and a small end dimension of 4 cm. Body 21 can have other sizes and shapes including round and square. Plastic, metal and composite materials can be used to make body 21. An elongated tapered inside wall 24 of body 21 surrounds a tapered passage 26 for carrying air from spout 13, shown by arrows 27, to open end 23 and out as a stream of air to a desired location, shown by arrow 28.

A heater assembly 29 located in passage 26 down stream from spout 13 operates to heat air flowing through passage 26 whereby the stream of air 28 is hot air directed to a desired location, such as a frozen pipe or ice and snow covered surfaces. Heater assembly 29 has a sleeve 31 located in engagement with the inside wall 24 of body 21. Sleeve 31 has an outside tapered surface that wedges into surface contact with the adjacent tapered inside wall 24 of body 21 thereby holding heater assembly 29 in a fixed position within nozzle 14. Sleeve 31 is a rigid heat insulation material, such as ceramic and composite materials, with a heat reflective inside layer or coating 32, such as metal. An electrical resistant heating element 33, shown as a wire coil, is located within sleeve 31 and spaced from layer 32. An electrical insulation support 34 holds element 33 in a generally central location in sleeve 31 spaced from layer 32. Insulation support 34 is shown as crossed plate members anchored to layer 32. Other types of heating elements and supports can be used in sleeve to heat air flowing through the passage of sleeve 31. Opposite ends of heating element 34 are connected to electric lines or conductors 36 and 37 coupled to switch 19. Lines 36 and 37 are enclosed in a cable 38 or tube joined to the bottom of nozzle 14. Lines 36 and 37 can be located within passage 26 and joined to a connector spout 13 electrically connected to switch 19. Switch 19 is a three position switch having a central OFF position, a first ON position wherein the electric motor is operated and a second ON position wherein the electric motor is operable and electric power is supplied to the hearing element. When switch 19 is in the first ON position cool air flows through air blower 10. When switch 13 is in the second ON position the heating element 34 heats the air flowing through nozzle 14. The air drawn into base 12 and housing 11 and moved by the impeller driven by motor 15 is subject to heat from the heater element 33. The heating element 33 also radiates heat to layer 32. The air flowing adjacent layer 32 is heated in addition to being heated by the heating element 33.

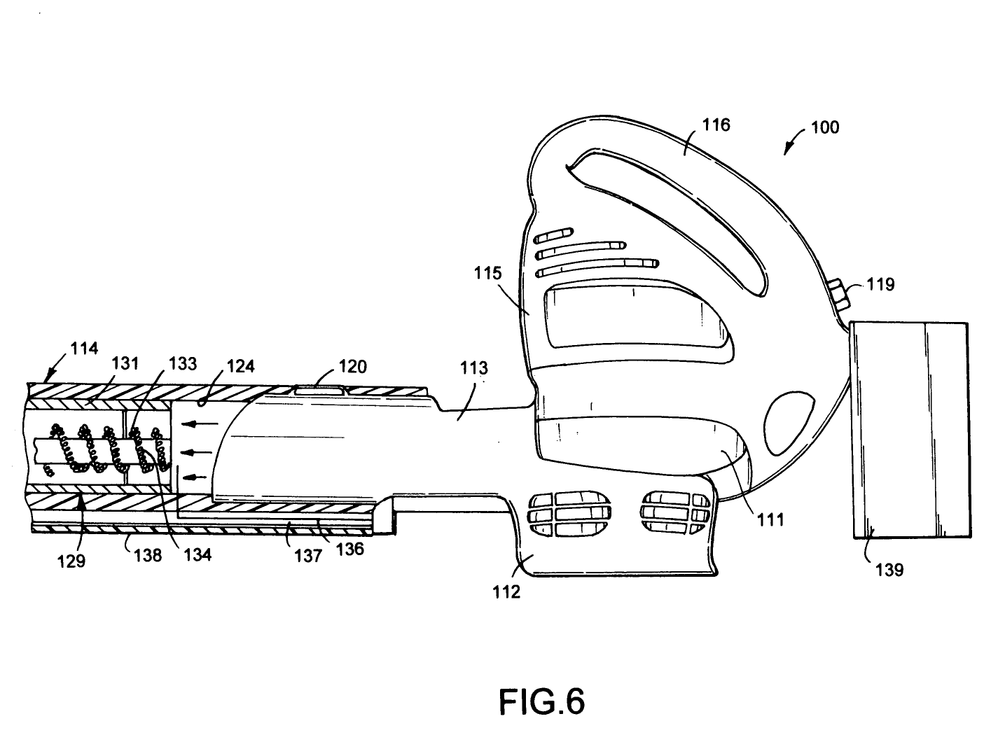

A first embodiment of the hot air blower, shown in FIG. 6 and indicated as 100, operates to discharge heated air to selected locations. The parts of air blower 100 that correspond to the parts of air blower 10 have the same reference numbers with the prefix 1. Air blower 100 has a generally cylindrical housing 111 having an internal chamber containing a fan or impeller for moving air through air blower 100. Housing 111 is joined to a base 112 having a plurality of openings to allow ambient air to flow into housing 111. A laterally extended spout 113 joined to housing 111 releasably supports an elongated tubular nozzle 114. Nozzle 114 telescopes over a section of spout 113 and held thereon with a releasable button or lock member 120. An electric heater assembly 129 located within nozzle 114 downstream from spout 113 operates to heat air flowing through nozzle 114. The air in housing 111 and spout 113 is not heated. Heater assembly 129 has an insulation sleeve 131 fixed to nozzle 114. Sleeve 131 can be wedged into contact with the inside wall 124 of nozzle 114. Also, fasteners can be used to secure sleeve 131 to nozzle 114. A heating element 133, shown as a wire coil, mounted on a nonconductor support 134 operates to heat air flowing through sleeve 131 and nozzle 114. Heating element 133 is wired with lines or electrical conductors 136 and 137 to switch 119 mounted on the back of handle 116. Lines 136 and 137 are encased in a cable 138 joined to the bottom of nozzle 114 and spout 113. DC electric power is supplied to air blower 100 with a battery pack 139, such as a 18 volt nicad battery. Battery pack 139 is mounted on the rear of handle 116 below switch 119. Motor 115 is a dc electric motor wired to switch 119 which is operable to vary the operated speed of motor 115. Switch 119 has a first ON position wherein only motor 115 operates to drive the impeller to move air into nozzle and a second ON position wherein motor 115 operates to drive impeller and supplies electric power to the heating element whereby air flowing in nozzle 114 is heated and discharged to a selected location.

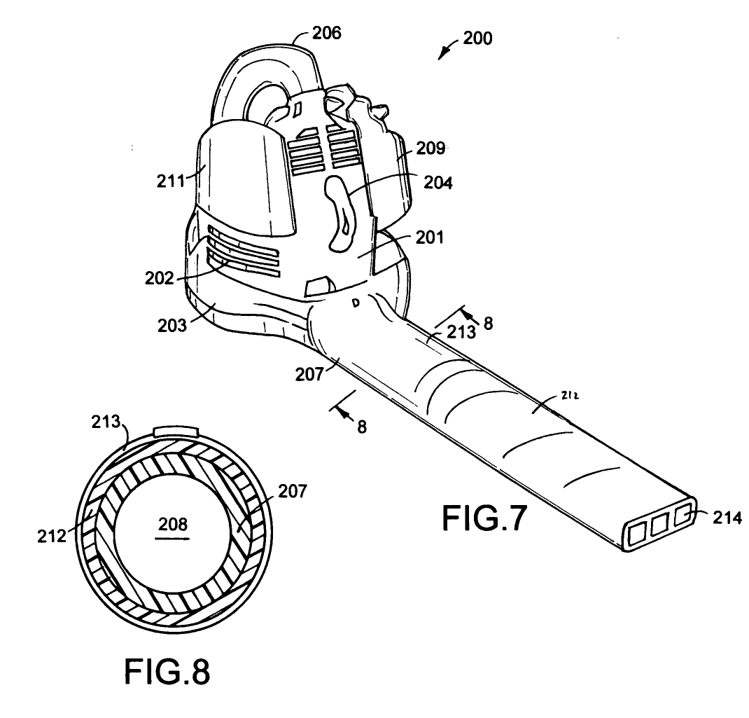

A second embodiment of the air blower 200, shown in FIG. 7, has an internal combustion engine located within a housing 201 operable to drive a blower or impeller to move a stream of air to a selected location. Housing 201 has air inlet openings 202 to allow ambient air to be drawn into an impeller section 203 by rotation of an impeller or fan drivably connected to the engine 204. A spout 207 extended laterally from impeller section 203 has a spout passage 208 for the air moved by the impeller. An inverted U-shaped handle 206 joined to the top of housing 201 is useable to manually transport air blower 200. A fuel supply unit 209 mounted on one side of housing 201 functions to supply hydrocarbon fuel to engine 204. An exhaust unit 211 has a muffler to reduce the noise of engine 204.

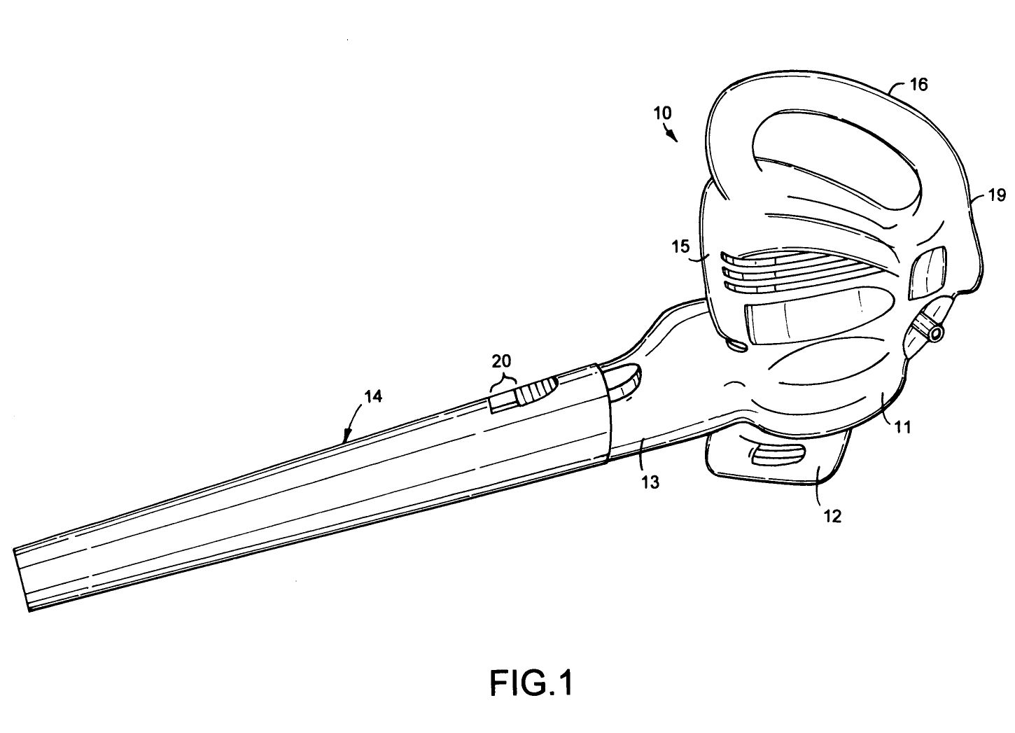

An elongated nozzle 212 comprising a linear tubular member, such as a plastic or metal tube, is telescoped onto spout 209. As shown in FIG. 10, spout 207 extends into the forward end of nozzle 212. A band clamp 213 located around nozzle 212 retains nozzle 212 on spout. Band clamp 213 can be released to allow nozzle 212 to be removed from spout 207. Other types of retainers, such as the biased buttons 20 and 120 shown in FIGS. 1 and 6, can be used to releasably hold nozzle 212 on spout 207. Nozzle 212 has an air exit open end 214 and an air passage 217 along the length thereof for carrying air from the nozzle passage 208 to open end 214 and dispense air shown by arrows 216 into atmosphere. The operator with handle 206 directs the air flowing from nozzle 212 to selected locations and objects. Nozzle 212 is shown as a linear cylindrical tube having a uniform diameter. Nozzle 212 can have a tapered shape with a large air inlet end open to a converging air passage extended to an air exit opening. The air exit opening can have circular, oval or transverse slit-like configurations.

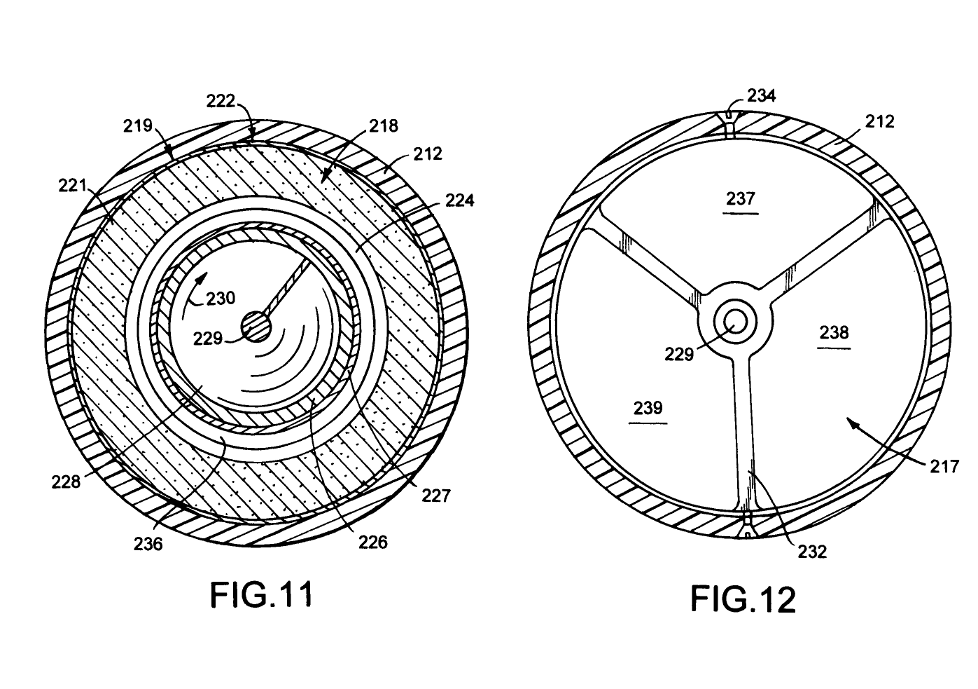

A heater assembly 218 located in nozzle passage 217 operates to increase the temperature of the air or heat the air flowing through nozzle passage 217 and into the atmosphere. Heater assembly is a magnet heater having a ferrous metal ring 219 supporting one or more permanent magnets 221. One or more fasteners 222 secure ring 219 to the inside wall of nozzle 212. Ring 219 has spaced radial flanges 223 and 224 with circular inside ends. The inside ends of flanges 223 and 224 are located radially inward from the inside surface of magnet 221 whereby the magnet flux forces are concentrated around the circular inside ends of flanges 223 and 224. A ferrous metal sleeve 226 located along the longitudinal axis of passage 217 supports a cylindrical copper member 227. The outside cylindrical surface of sleeve 226 is in continuous surface contact with cooper member 227 whereby heat is uniformly conducted between copper member 227 and above 226. A helical member or screw 228 secured to a longitudinal shaft 229 is located within the passage of sleeve 226. The outer peripheral edge of helical member 228 is secured to sleeve 226 whereby sleeve 226, copper member 227 and helical member 228 rotate in the direction of arrow 230 caused by air flowing in nozzle passage 217. The opposite ends of shaft 229 are rotatably supported on sleeve bearings on support plates 231 and 232. Fasteners 233 and 234, such as bolts, secure plates 231 and 232 to nozzle 212 adjacent opposite ends of sleeve 226 and copper member 227. As shown in FIG. 11, copper member 227 and flanges 223 and 224 are radially separated within an annular gap or space 236 to allow the sleeve 226 and copper member 227 to rotate relative to magnet 221. The magnetic flux in space 236 during the rotation of sleeve 226 and copper member 227 generates heat which is conducted by copper member 227 to sleeve 226 and helical member 228. The heat is transferred to the air flowing in annular space 236 and through helical member 228. The hot air flows through openings 237 in support plate 232. As shown in FIG. 12 support plate 232 has three openings 237, 238 and 239 which allows air to flow in nozzle passage 217. The cross sectional area of annular space 236 and the inside of sleeve 226 is smaller than the cross sectional area of nozzle passage 217 whereby the velocity of the air flowing through annular space 236 and sleeve 226 is increased thereby rotating sleeve 226 and cooper member 227 and generating heat. This causes the temperature of the air flowing through the heater assembly to increase whereby hot air flows out of nozzle 212.

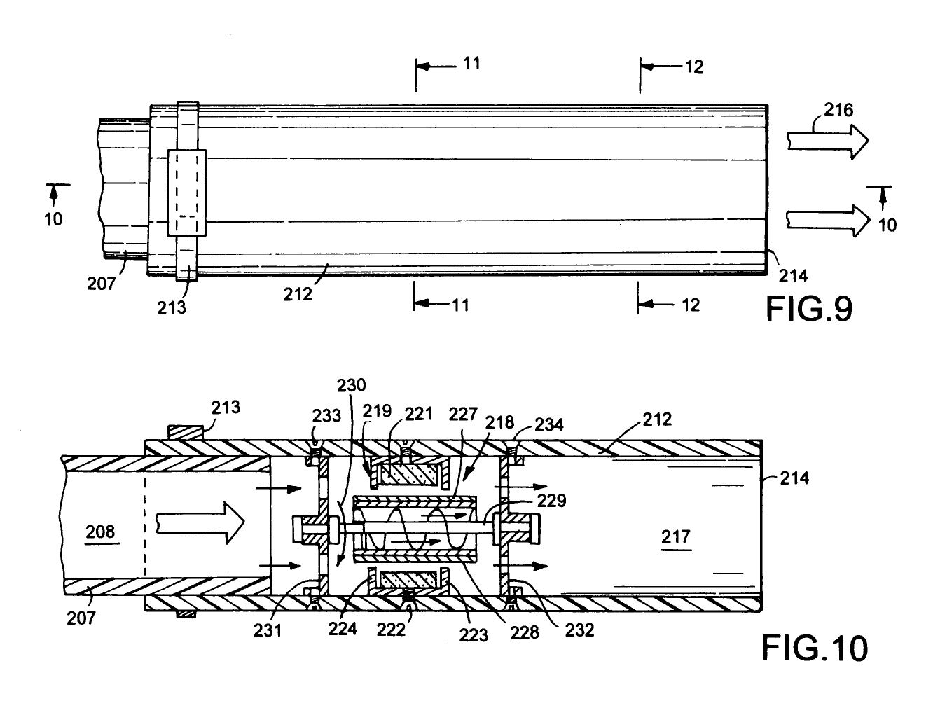

The nozzle 212 and heater assembly 218 shown in FIGS. 9 to 12 can be releasably connected to an air mover driven with an electric motor as illustrated in FIG. 1. The air flowing out of the spout into the nozzle is heated with the heater assembly as herein described.

A heat exchanger associated with muffler or exhaust structure of the internal combustion engine can be used to pre-heat air flowing in spout 207. Additional changes and modifications of the nozzle and heater assembly can be made by persons skilled in the art without departing from the invention.

The air blower of the invention has been shown and described with respect to particular embodiments thereof. It is understood that variations and modifications of the size, materials and parts of the air blower can be made by persons skilled in the art without departing from the scope of the invention defined in the appended claims.

1. An apparatus for moving air comprising:
a housing having a handle for manually carrying the apparatus, an internal chamber, an air inlet passage open to the internal chamber, a spout having an air exit passage open to the internal chamber,
a motor located within the internal chamber, an air moving device located in the internal chamber and mounted on the housing,
a power transmission drive connecting the motor to the air moving device whereby the motor operates the air moving device to draw air through the air inlet passage and discharge air through the air exit passage of the spout,
an elongated tubular member having a passage and an air exit end opening to allow air to flow to atmosphere, said tubular member being mounted on the spout with the air exit passage of the spout in communication with the passage of the tubular members,
a heater assembly located in the passage of the tubular member operable to heat air flowing in the passage of the tubular member,
at least one support mounting the heater assembly on the tubular member, said heater assembly being operable to heat the air flowing in the passage of the tubular member whereby heated air is discharged from the air exit and opening of the tubular member to atmosphere.

2. The apparatus of claim 1 wherein:
the motor is an electric motor, and
a switch mounted on the housing operable to connect and disconnect an electric power supply to the electric motor whereby the motor operatives the air moving device.

3. The apparatus of claim 2 wherein:
the heater assembly includes an electric heating element wired to the switch whereby when the switch connects the electric motor to the electric power supply, the electric heating element is connected to the electric power supply to heat air flowing in the passage of the tubular member.

4. The apparatus of claim 1 wherein:
the air moving device is an impeller drivably connected to the motor, said impeller being rotatably mounted on the housing.

5. The apparatus of claim 1 wherein:
the motor is an internal combustion engine.

6. The apparatus of claim 5 wherein:
the heater assembly includes a heat generator having a rotatable first member and a second member responsive to flowing air in the passage of the tubular member to rotate the first member to heat the air flowing in the passage of the tubular member.

7. The apparatus of claim 5 wherein:
the heater assembly includes a heat generator having a rotatable cylindrical metal member having an outer surface, a copper member located on the outer surface of the metal member, at least one magnet mounted on the tubular member spaced from the copper member and inclined members connected to the cylindrical metal member responsive to flowing air in the passage of the tubular member to rotate the cylindrical metal member whereby the magnet, copper and metal members heat air flowing in the passage of the tubular member.

8. The apparatus of claim 7 wherein:
the inclined members are helical members located within the metal member.

9. The apparatus of claim 7 wherein:
the inclined members are fan blades connected to cylindrical member.

10. The apparatus of claim 1 including:
a releasable latch for holding the tubular member on the spout and allowing the tubular member to be removed from the spout.

11. The apparatus of claim 1 wherein:
the heater assembly includes a sleeve located within the passage of the tubular member, an electric heating element located within the sleeve, and a switch wired to the electric heating element operable to connect and disconnect an electric power supply to the electric heating element.

12. The apparatus of claim 11 wherein:
the motor comprises an electric motor wired to said switch whereby the electric motor and heating element are concurrently operated.

13. An apparatus for moving air comprising:
a housing having an upwardly extended handle for manually carrying the apparatus, an internal chamber, at least one air inlet passage open to the internal chamber to allow external air to flow into the internal chamber, an outwardly extended spout having an air exit passage open to the internal chamber,
a motor located within the internal chamber,
an impeller located within the internal chamber and rotatably mounted on the housing,
a power transmission connecting the motor to the impeller whereby the motor rotates the impeller to draw air through the air inlet passage and discharge air through the air exit passage of the spout,
an elongated tubular nozzle having a first end telescoped over a section of the spout, a second end having an air exit opening and an air passage extended through said nozzle open to the passage of the spout whereby air flows through the passage of the spout and nozzle,
a releasable latch cooperating with the spout and the first end of the nozzle for holding the nozzle on the spout end allowing the nozzle to be removed from the spout,
a heater assembly located in the passage of the nozzle operable to heat air flowing in the passage of the nozzle, said heater assembly including a sleeve located in the passage of the spout and an electric heating element located within the sleeve, and
a switch wired to the electric motor and electric heating element operable to connect and disconnect an electric power supply to the electric motor and electric heating element whereby the heating element heats air flowing in the nozzle and discharges heated air from the nozzle.

14. The apparatus of claim 13 including:
a housing connected to the blower, said housing having an internal chamber accommodating the electric motor.

15. The apparatus of claim 14 including:
at least one handle connected to the housing for manually carrying the apparatus.

16. An apparatus for moving air comprising:
an internal combustion engine having a drive shaft, a blower having an impeller drivably connected to the drive shaft of the engine,
a spout connected to the blower, said spout having a passage for accommodating air flowing from the blower,
an elongated tubular nozzle having a first end connected to the spout, a second end having an air exit opening and an air passage extended through said nozzle open to the passage of the spout whereby air flows through the passages of the spout and nozzle, and
a heater assembly located in the passage of the nozzle operable to heat the air flowing in the passage of the nozzle and discharge heated air from the nozzle.

17. The apparatus of claim 16 wherein:
the heater assembly includes a heat generator having:
a rotatable cylindrical metal member having an outer surface,
a copper member located on the metal member,
at least one magnet secured to the tubular member adjacent the cooper member,
inclined members connected to the metal member,
a longitudinal shaft connected to the inclined members, and
support members secured to the nozzle rotatably supporting the shaft whereby air flowing in the nozzle passage rotates the inclined members and metal and copper members relative to the magnet whereby heat is generated to heat the air flowing in the passage of the nozzle and discharged from the nozzle.

18. The apparatus of claim 16 wherein:
the inclined members include at least one helical member located within and secured to the metal member.

19. The apparatus of claim 16 including:
a housing connected to the blower, said housing having an internal chamber accommodating the internal combustion engine.

20. The apparatus of claim 19 including:
at least one handle connected to the housing for manually carrying the apparatus.
